(19) United States
(12) Patent Application Publication
(10) Pub. No.: US 2019/0050774 A1
(43) Pub. Date: Feb. 14, 2019

(54) METHODS AND APPARATUS TO ENHANCE EMOTIONAL INTELLIGENCE USING DIGITAL TECHNOLOGY

(71) Applicant: General Electric Company, Schenectady, NY (US)

(72) Inventors: Lucas Jason Divine, West Allis, WI (US); Lauren A. Russo, Mamaroneck, NY (US); Brian Shannon, San Diego, CA (US); Ophira Bergman, San Diego, CA (US); Megan Wimmer, Waukesha, WI (US)

(21) Appl. No.: 15/671,789

(22) Filed: Aug. 8, 2017

(51) Int. Cl. G06Q 10/06

(52) U.S. Cl. CPC G06Q 10/06316; G06F 17/2881

(57) ABSTRACT

Methods, systems, and apparatuses are disclosed herein that output suggestions to users based on current or upcoming inter-personal interactions. Digital technology can be used to understand situations, relationships, and context to help improve the emotional intelligence of users as they engage in such inter-personal interactions. The system can receive inputs about the current situation, environment, users, and other factors. These inputs can be used to determine emotional states of the user and other participants. Based on determined emotional states, the system can suggest one or more outputs to a user to help improve the inter-personal interaction.

### TECHNICAL FIELD OF THE DISCLOSURE

This disclosure relates generally to digital technology and, more particularly, to enhancing emotional intelligence using digital technology.

### BACKGROUND

In the workplace, employee and customer satisfaction and job performance can be directly linked that employee's emotional state. A driving force in how an employee feels is a quality and tone of interactions that the employee has with other employees and management. People like warm, kind and encouraging interactions with other people. Outcomes of workplace interactions are often driven by subtle social cues and the responses and moods of those involved in the interaction.

Emotions can impact team and other inter-personal dynamics. “Positive” emotions (e.g., happiness, satisfaction, belonging, friendship, appreciation, etc.) can benefit team dynamics and productivity, while “negative” emotions (e.g., sadness, loneliness, uselessness, disrespect, anger, etc.) can harm team dynamics and productivity, for example. Improving team dynamics can have a significant impact on company performance, for example.

In the medical field, a relationship between healthcare professional and patient is especially critical. Happier, confident healthcare professionals make less mistakes and have more positive relationships with patients. Happier patients have better healthcare outcomes and contribute to a more positive healthcare environment. Computer systems to help achieve such outcomes have yet to be developed.

### BRIEF DESCRIPTION OF THE DRAWINGS

FIG. 1 is an illustration of example context processing and interactional output generating system.

FIG. 2 provides further detail regarding an example implementation of the system of FIG. 1.

FIG. 3 provides a more specific implementation of FIG. 2 illustrating the example system of FIG. 1.

FIG. 4 is an example implementation of the potential emotions identifier of the example of FIG. 3.

FIG. 5 illustrates an example implementation of the communication suggestion engine of the example of FIG. 3.

FIGS. 6-10 illustrate flow diagrams representative of example methods of enhancing emotional intelligence through generating and providing social cues and interaction suggestions via the example systems of FIGS. 1-5.

FIGS. 11-13 illustrate example output provided via digital technology 250 to a user.

FIG. 14 is a block diagram of an example processing platform structured to execute machine-readable instructions to implement the methods of FIGS. 6-10, the systems of FIGS. 1-5, and the output of FIGS. 11-13.

Features and technical aspects of the system and method disclosed herein will become apparent in the following Detailed Description set forth below when taken in conjunction with the drawings in which like reference numerals indicate identical or functionally similar elements.

### BRIEF SUMMARY

Methods and apparatus to generate emotional communication suggestions for users based on environmental and profile data are disclosed and described.

Certain examples provide an apparatus including a memory to store instructions and a processor. The processor is to be particularly programmed using the instructions to implement at least: an emotion detection engine to identify a potential interaction involving a user and a participant and process input data including digital information from a plurality of workplace and social information sources compiled to form environment data and profile data for the participant and the interaction, the emotion detection engine to identify a set of potential emotions for the participant with respect to the interaction based on the environment data, the profile data, and an emotional context and to process the set of potential emotions to identify a subset of emotions smaller than the set of potential emotions; a communication suggestion crafter to receive the subset of emotions and generate at least one suggestion for the user with respect to the participant and the interaction by matching one or more of the emotions from the subset of emotions to a suggested response for a given social context; and an output generator to formulate the at least one suggestion as an output to the user via digital technology.

Certain examples provide a computer readable storage medium including. The instructions, when executed, cause a machine to at least: identify a potential interaction involving a user and a participant; process input data including digital information from a plurality of workplace and social information sources compiled to form environment data and profile data for the participant and the interaction; identify a set of potential emotions for the participant with respect to the interaction based on the environment data, the profile data, and an emotional context; process the set of potential emotions to identify a subset of emotions smaller than the set of potential emotions; generate at least one suggestion for the user with respect to the participant and the interaction by matching one or more of the emotions from the subset of emotions to a suggested response for a given social context; and formulate the at least one suggestion as an output to the user via digital technology.

Certain examples provide a method including identifying, using a processor, a potential interaction involving a user and a participant. The example method includes processing, using the processor, input data including digital information from a plurality of workplace and social information sources compiled to form environment data and profile data for the participant and the interaction. The example method includes identifying, using the processor, a set of potential emotions for the participant with respect to the interaction based on the environment data, the profile data, and an emotional context. The example method includes processing, using the processor, the set of potential emotions to identify a subset of emotions smaller than the set of potential emotions. The example method includes generating, using the processor, at least one suggestion for the user with respect to the participant and the interaction by matching one or more of the emotions from the subset of emotions to a suggested response for a given social context. The example method includes formulating, using the processor, the at least one suggestion as an output to the user via digital technology.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is, therefore, provided to describe an exemplary implementation and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

Throughout the specification and claims, the following terms take the meanings explicitly associated herein, unless the context clearly dictates otherwise.

The term “interaction,” as used herein, refers to a shared social experience between one or more people involving an exchange of communication between these people. In some examples, this communication is verbal. In other examples, communication can be any combination of written, verbal or nonverbal communication (e.g., body language, facial expression, etc.). The interaction may be by people within physical proximity and/or people who are connected via computer technologies, for example.

The term “social context”, as used herein, is a context related to factors linking people involved an interaction together (e.g., the “relational context”), environmental information and user preferences. Examples of relevant social context include, but are not limited to, one person being the other's manager, a shared love of a sports team, a time of day, culture(s) of the participants involved, etc. Whether or not people have been on the same team for a while, personal updates people have chosen to share, familiar phrases or speech patterns, etc., can also form part of the social context, for example.

The term “emotional context”, as used herein, is a context related to the emotional backgrounds of the participants in the interaction. An emotional history, current emotional state, a relational emotion, etc., can help to understand the meaning of a participant's communication during an interaction, for example. Examples of emotional context include a participant feeling “busy” or “overwhelmed” based on the number of meetings he or she had that day as may be determined from explicit remarks and/or based on a digital calendar, or a participant may feel “bored” as may be determined from explicit remarks and/or based on their heartrate and posture, etc.

The term “artificial intelligence (AI) learning”, as used herein, refers to a process by which a processor processes input and correlates input to output to learn patterns in relationships between information, outcomes, etc. As the processor is exposed to more information, feedback can be used to improve the processor's “reasoning” to connect inputs to outputs. An example of AI learning is a neural network, which can be implemented in a variety of ways.

While certain examples are described below in the context of medical or healthcare workplaces, other examples can be implemented outside the medical environment. For example, in certain examples, can be applied to interactions in business or retail workplaces and those outside of the workplace.

### Overview

Advances in natural language processing, sentiment analysis, and machine learning have unlocked new capability in human-computer communication. Natural Language Processing (NLP) allows computers to understand and generate normal everyday language for use in interactions with people. Sentiment analysis allows a computer to identify tone and feelings of a person based on inputs to a computer. Machine learning facilitates pattern recognition and helps improve accuracy and efficiency when given feedback and practice.

Improving the quality and outcome of workplace interactions can have many benefits such as improving employee management and team dynamics, creating a more positive workplace environment, and encouraging better cross-team relationships. In the medical field, improvements include happier medical workforces, more lives saved, and fewer mistakes made during procedures. Additionally, improving patient and healthcare professional interactions can led to better emotional treatments, fewer re-admissions, and faster recoveries. Providing specific communication suggestions can also assist with communicational or social impairments (e.g., autism, Asperger's syndrome, etc.) by helping practitioners recognize and react to social cues during interactions.

Certain examples provide technology-driven systems and associated methods to process information, such as personal, historical, and context data, etc., and provide resources for interaction between a user and one or more other individuals. Certain examples facilitate machine learning and improved social/contextual process to provide appropriate social cues and/or other suggestions to improve conversation and/or other interaction for improved workplace satisfaction and performance.

Certain examples provide technological improvements in sensing, processing, and deductive systems to identify emotions, underlying emotional causes, correlations between events and emotions, and correlations between emotions, situations, and responses that are unknowable by humans. Not only to certain examples improve emotional interactions, but certain examples provide new data, input, etc., that are otherwise unavailable/unobtainable without the improved technology described and disclosed herein.

### Example Systems and Associated Methods

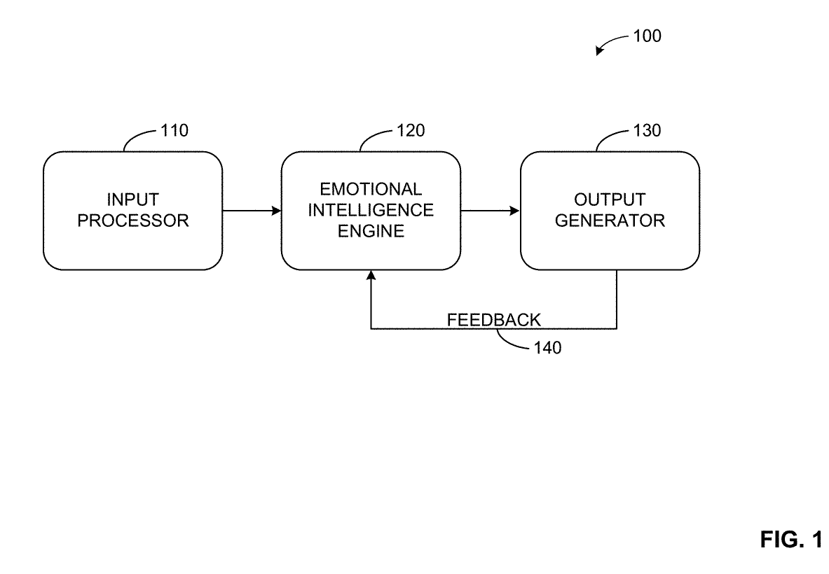

FIG. 1 is an illustration of example context processing and interactional output generating system 100. The example system 100 includes an input processor 110, an emotional intelligence engine 120, and an output generator 140. Additionally, feedback 140 from the output generator 130 is provided to the emotional intelligence engine 120. In some examples, the input processor 110 receives, captures, and/or generates data collected from the environment (e.g., time, location, climate data, etc.).

In some examples, input processor 110 includes data related to the user(s) involved in the interaction, also called profile data (e.g. employee records, emotional profiles, biometric data, etc.). The input processor 110 can obtain data for user(s), healthcare facility, user role, schedule, appointment, and/or other context information from one or more information systems such as a picture archiving and communication system (PACS), radiology information system (RIS), electronic medical record (EMR) system, laboratory information system (LIS), enterprise archive (EA), demographic database, personal history database, employee database, social media website (e.g., Facebook™, LinkedIn™, Twitter™, Instagram™, etc.), scheduling/calendar system (e.g., Outlook™, iCal™, etc.).

In some examples, the emotional intelligence engine 120 uses information from the input processor 110 to model, predict, and/or otherwise suggest one or more specific responses, suggestions, context information, social cues, and/or other interaction guidance for one or more users in one or more social situations/scenarios. For example, the emotional intelligence engine 120 processes personal history, scheduling, and social media input for first and second participants soon to be involved in conversation and/or in another social situation to provide the first participant with helpful suggestions to ease a positive interaction with the second participant. The emotional intelligence engine 120 can model likely outcome(s), preferred topic(s), suggestion mention(s), and/or other social cues to help ease an interaction based on historical data, prior calculations, and input for a current situation/scenario, for example. Information from the engine 120 is provided to the output generator 130.

In some examples, the output generator 130 provides a notification to the user and specific communication suggestions for a given situation, context, interaction, encounter, etc. Feedback 140 from the output generator 130 can also be provided back to the emotional intelligence engine 120 to help improve social cues and/or other emotional responses, context suggestions, etc., generated by the emotional intelligence engine 120, for example. Thus, the output generator 130 can form background information, overview, suggested topic(s) of conversation, alert(s), and/or other recommendation(s)/suggestion(s), for example, and provide them to the user via one or more output mechanisms, such as audio output (e.g., via a headphone, earpiece, etc.), visual output (e.g., via phone, tablet, glasses, watch, etc.), tactile/vibrational feedback (e.g., via watch, bracelet, etc.), etc. In some examples, the user can provide feedback and/or other input regarding the success or failure of the recommendation/suggestion, ease of implementation of the recommendation/suggestion, follow-up to the recommendation/suggestion, and/or other information that can be used by the emotional intelligence engine 120 for modeling and/or other processing for future interaction. The system 100 may also automatically detect the results of the interaction, via microphone, user text messages, etc.

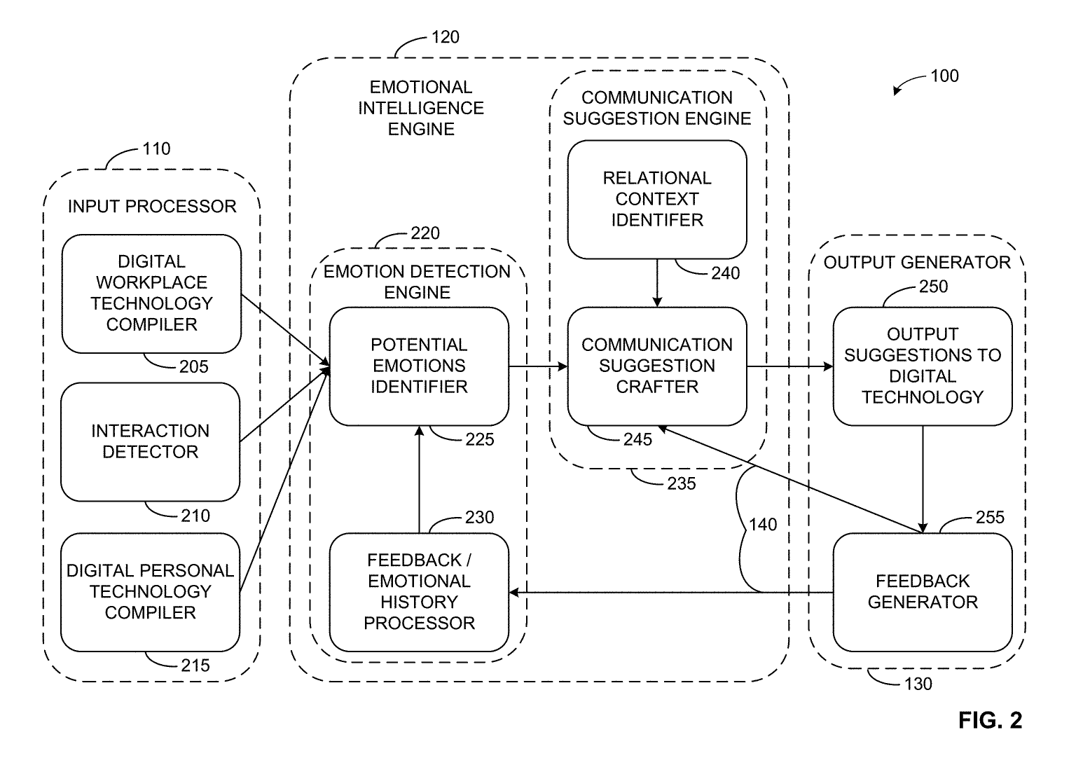

FIG. 2 provides further detail regarding an example implementation of the system 100 of FIG. 1. As shown in the example of FIG. 2, the input processor 110 includes a digital workplace technology compiler 205, an interaction detector 210, and a digital personal technology compiler 215.

In some examples, the digital workplace technology compiler 205 compiles and/or otherwise processes information from a plurality of data sources including workforce management records, employee calendars, employee communication logs, and/or other related information regarding a workplace such as a healthcare facility and/or other place of business, etc. For example, the digital workplace technology compiler 205 leverages one or more other software applications including a shift scheduling application, calendar application, chat and/or social applications (e.g., Skype™, Jabber™, Snapchat™, Facebook™, Yammer™, etc.), email, etc., to gather information regarding a user and/or other interaction participant(s). The digital workplace technology compiler 205 can also capture location information (e.g., radio frequency identifier (RFID), near field communication (NFC), global positioning system (GPS), beacons, security badge scanners, chair sensors, room light usages, Wi-Fi triangulation, and/or other locator technology), camera/image capture data (e.g., webcam on laptop, selfie camera on smartphone, security camera, teleconference room cameras, etc.) to detect facial expression/emotion, and audio capture data (e.g., microphone on computers, security cameras, smartphones, tablets, etc.), as examples. In a healthcare context, the digital workplace technology compiler 205 can leverage medical information such as electronic medical record (EMR) content (e.g., participant medical issue(s), home life, attitude, etc.), patient classification system (PCS) information (e.g., identify patient issues associated with a user to help evaluate an amount of work involved for the user to care for the patient, etc.), etc. A hospital “virtual rounds” robot can also provide input to the digital workplace technology compiler 205, for example. In other workplace contexts, wherever digital data is captured and stored can be a source of relevant information for the workplace technology compiler 205.

In certain examples, a digital twin or virtual model of a patient and/or other potential interaction participant can be used to model, update, simulate, and predict a likely emotion, issue, outcome, etc. The digital workplace technology compiler 205 can maintain the digital twin, for example, to be leveraged by the emotional intelligence engine 120 in its analysis.

Digital twins can be applied not only to individuals, but also to teams. For example, a group of multiple people and/or resources can be modeled as a single digital twin focusing on the aggregate behavior of the group. In some examples, a digital twin can model a team while digital twins within that digital twin (e.g., sub-twins) model individuals in the team. Thus, aggregate team behavior and/or individual behavior, emotion, etc., can be modeled and analyzed using digital twin(s). For example, an ER team (e.g., including and/or in addition to a digital twin of an ER nurse on the team, etc.), a corporate management team, a product development team, maintenance staff, etc., can be modeled individually and/or together as a team using digital twin(s).

In certain examples, the digital workplace technology compiler 205 can monitor and/or leverage monitoring of phone calls to determine who is calling, calling frequency, etc., to provide input to enable identification of emotional connections between individuals (by the emotional intelligence engine 120). If the person is a non-work individual calling while the user is at work, then the relationship between the user and the person is likely a close relationship, for example. Longer calls may indicate more emotional expression, for example. Whether or not a person accepted a call during an appointment may indicate the call's importance (e.g., if yes, then more important), and whether or not a person declined taking a call because of work may also indicate the call's importance (e.g., if yes, then less important), for example. If a person is not taking any calls, the person may be depressed, for example. If a person was late to an appointment due to an email and/or phone call, then the topic of the email/phone call was likely important, for example.

In certain examples, the digital workplace technology compiler 205 can query and/or leverage a query of a user and/or other individual to gather further information. For example, an individual (e.g., employee, patient, etc.) can be queried via a survey/questionnaire to determine how they are feeling (e.g., sad face, ordinary face, smiley face, etc.). Obtaining digitally submitted feedback from employees is an increasing practice at companies. This feedback about teamwork, emotional feelings such as trust and positivity, and perceptions about the company's effectiveness can be useful sources of data for the systems and methods herein. Certain examples enable an employer to use such data for more than just a survey, but to also improve teams and interactions of employees, providing strong value to a company.

Thus, the digital workplace technology compiler 205 can gather and organize a variety of data from disparate sources to help the emotional intelligence engine 120 process and identify likely emotion(s) and/or other contextual elements factoring in to an interaction between people, for example.

In some examples, the interaction detector 210 detects when an interaction is about to occur, or is occurring, between individual people or teams (e.g., referred to herein as participants, etc.). The interaction detection can trigger the processes herein to generate an emotional intelligence output.

The interaction detector 210 can gather location information such as from radiofrequency identification (RFID) information, beacons, smart technologies such as smart phone, video detection, etc. Alternatively, or in addition, the interaction detector 210 monitors user scheduling, social media content (e.g., LinkedIn™, Facebook™ Twitter™, Instagram™, etc.), nonverbal communication (e.g. body language, facial recognition (e.g., mood sensing, etc.), tone of voice, etc.), etc., to gather information for the engine 120. In some examples, the digital personal technology compiler 215 compiles and/or otherwise processes information from a plurality of data sources including smart phone and/or tablet information, laptop/desktop computer application usage, smart watch and/or smart glasses data, user social media interaction, etc. The interaction detector 210 uses the information to determine if an interaction is about to occur or is occurring.

The digital workplace technology compiler 205, interaction detector 210, and digital personal technology compiler 215 work together to generate input for the input processor 110 to provide to the emotional intelligence engine 120. The input processor 110 leverages the compilers 205, 215 and detector 210 to organize, normalize, cleanse, aggregate, and/or otherwise process the data into a useful format for further evaluation, processing, manipulation, correlation, etc., by the emotional intelligence engine 120, for example.

As shown in the example of FIG. 2, the emotional intelligence engine 120 includes an emotion detection engine 220, which includes a potential emotions identifier 225 and a feedback/emotional history processor 230. The example implementation of the engine 120 also includes a communication suggestion engine 235, which includes a relational context identifier 240 and a communication suggestion crafter 245.

In operation, when provided with input data from the input processor 110, the emotion detection engine 220 provides the input to the potential emotions identifier 225. The emotion detection engine 220 also provides feedback and/or other emotional history information to the potential emotions identifier 225 via the feedback/emotional history processer 230. The emotion detection engine 220 then outputs results of the potential emotions identifier 225 to the communication suggestion engine 235.

In certain examples, the communication suggestion engine 235 generates specific communication suggestions using the communication suggestion crafter 245. The communication suggestion crafter 245 also receives data relating to parties involved in an ongoing and/or potential communication via the relational context identifier 240. The relational context identifier 240 is also referred to as relational context recognition engine or social context generator and provides one or more factors related to parties involved in an interaction.

For example, the relational context identifier 240 provides context information for participants in an interaction to help make a communication suggestion feel genuine for the user when interacting with another participant (e.g., helping to avoid “weird” or “awkward” conversational moments, etc.). This is very important in human interactions. The relational context identifier 240 can identify an organization relationship between participants (e.g., manager vs. employee, peers, relative pay band(s), title(s), etc.). The relational context identifier 240 can also evaluate a scale of “closeness” for the relationship between individuals. For example, is the relationship a professional and/or personal acquaintance and/or merely an affinity between the individuals. For each relationship, a scale from antagonistic to neutral to close can be scored, for example. The relational context identifier 240 can create a ranking based on available data (e.g., social network interaction, emails, calendar invitations, lunches together, time spent together, previous vocal conversations, etc.).

The relational context identifier 240 can also factor in team dynamics. For example, the identifier 240 can detect how person X works with person Y, as well as how person X works with person Z, etc., to identify which group of people works best together for best patient outcome, etc. Cultural context can also factor into the relational context evaluation. For example, ethnic background(s), age background(s) (e.g., millennial vs. baby boomer, etc.), etc., can factor in to a relational context dynamic. General personal background, such as traumatic experience, location(s) lived, sports affiliation, hobby/passion/interest, family status, etc., can also help the relational context identifier 240 identify a relational context.

In certain examples, the relational context identifier 240 takes into account workplace norms, policies, initiatives, beliefs, etc. For example, a company may recommend and/or otherwise encourage certain phrases, which can be taken into account when generating the wording for a communication suggestion. Thus, the communication suggestion crafter 245 can generate and/or promote suggestions that align with company initiatives, beliefs, rules, preferences, etc. In certain examples, a participant's standing, role, and/or rank in the company can factor into generated communication suggestion(s). For example, the higher up the person is in the company, the more weight is given to “company beliefs” to help ensure that person communicates according to “the company line”.

In certain examples, the communication suggestion crafter 245 can recommend communication(s) based on the user's prior communication/behavior. Thus, the user can be encouraged to continue working on and improving certain communication(s), communication with certain individual(s), etc.

The communication suggestion crafter 245 provides one or more context-appropriate communication suggestions to the user via the output generator 130. For example, the output generator 130 provides communication/social cue suggestions 250 to digital technology such as a smart phone, tablet, smart watch, smart glasses, augmented reality glasses, contact lenses, earpiece, headphones, laptop, etc. The digital output 250 can be visual output (e.g., words, phrases, sentences, indicators, emojis, etc.), audio output (e.g., verbal cues, audible translations, spoken sentence suggestions, etc., via Bluetooth™ headset, bone conduction glasses, etc.), tactile feedback (e.g., certain vibrations indicating certain moods, emotions, triggers, etc.), etc. For example, one vibration is a reminder to cheer up, and two vibrations is a reminder to ask questions regarding where the other person is coming from, etc.

As another example, colored lights can be used to communicate “emotional states” of the other party (e.g., red=grumpy, green=cheerful, blue=sad, yellow=unsure, etc.) via visual on a smart watch, smart glasses, smart contact lenses, smart phone, etc. Thus, a user can look around a room and see likely emotional states of people in the room based on a color of light illuminating in the smart glasses as the user looks at each person in the room, for example. The output can be colored for the person's general mood as well as the person's mood towards the user. Thus, a multi-light system can provide even more interesting output examples to allow users to understand emotional status of people in everyday and workplace interactions.

In some examples, a user preference for output 250 type, a user response to the output 250, an outcome of the interaction involving the output 250, etc., is provided by a feedback generator 255 as feedback 140 to the emotion detection engine 120 (e.g., to the feedback/emotional history processor 230, to the communication suggestion crafter 235, etc.).

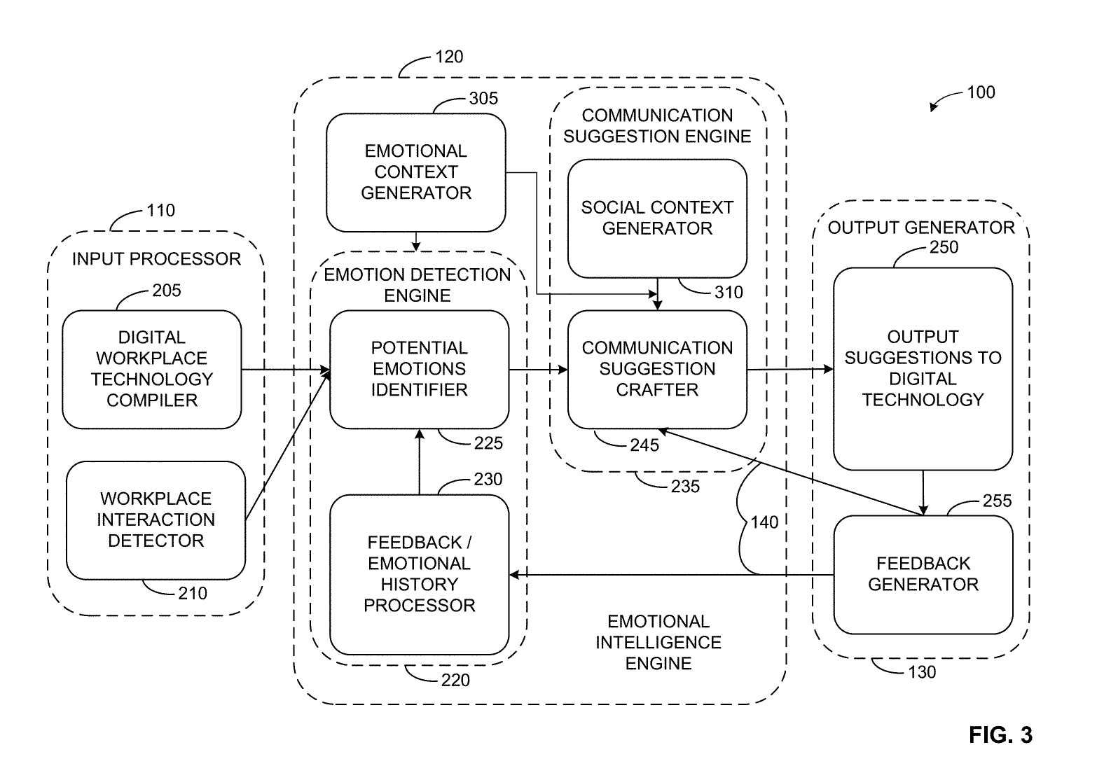

FIG. 3 provides a more specific implementation of FIG. 2 illustrating the example system 100 of FIG. 1. The example system 100 includes the input processor 110, the emotional intelligence engine 120 which operates on input from the input processor 110, and the output generator 130 which provides output to one or more users. Operational feedback 140 is provided to the emotional intelligence engine 120 to refine/adjust future communication/interaction suggestions from the engine 120.

In the example of FIG. 3, the system 100 is configured for workforce management (WFM) processing. In some examples, the workforce being managed is a workforce of healthcare professionals. In other examples, the workforce being managed is a workforce of business professionals, commercial employees, retail professionals, etc. In the example of FIG. 3, examples of digital workplace technology 205 include electronic medical records (EMR), patient classification solutions (PCS), shift management software (e.g., GE ShiftSelect™, etc.), and/or other healthcare WFM technology.

The emotional intelligence engine 120 of the example of FIG. 3 uses information from the input generator 110 to operate an emotional context generator 305 (providing input to the emotion detection engine 220) and a social context generator 310 (a particular implementation of the relational context identifier 240 providing input to the communication suggestion crafter 245). The emotional context generator 305 allows the emotion detection engine 220 to better operate the potential emotion identifier 225 with respect to interaction detected by the interaction detector 210. For example, using an emotional background and/or other emotion/tendency information regarding participants and/or other individuals, the emotional context generator 305 forms an emotional context describing a background, environment, and/or other context (e.g., a person's emotional background, etc.) from which a participant may be approaching an interaction. The social context generator 310 provides social context (e.g., environment, relationship between the user and a conversation participant, schedule, other current event(s), etc.) to the communication suggestion crafter 245 to generate the output 250 of suggestions to digital technology. Feedback 140 from the feedback generator 255 can be provided to the emotional intelligence engine 120.

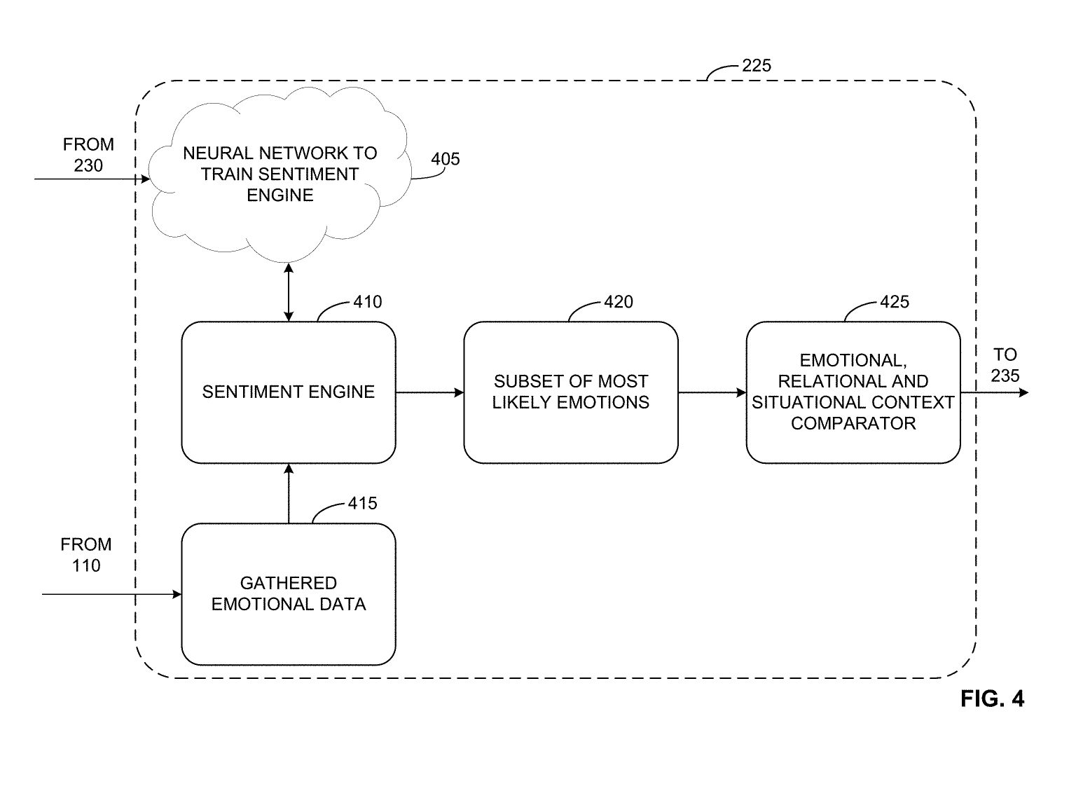

FIG. 4 is an example implementation of the emotions identifier 225 of the example of FIG. 3. The example identifier 225 includes a sentiment engine 410, trained by a neural network 405 and receiving gathered emotional data 415 to generate a subset of most likely emotions 420 present for a given interaction between people. In the example of FIG. 4, the potential emotions identifier 225 receives input from the input processor 110 including detection of an interaction 210, data from the digital workplace technology compiler 205, data from digital personal technology compiler 215, and other inputs that form and/or help to form the gathered emotional data 415.

In the example of FIG. 4, the input data is used to determine which emotions may be present and/or otherwise be a factor in an upcoming interaction (e.g., a current, future, and/or past interaction detected by the interaction detector 210). In the example of FIG. 4, the emotion determination process is driven by a sentiment engine 410 and a neural network 405. The sentiment engine 410 utilizes a sentiment analysis framework to identify and quantify the emotional state of the user based on the input processor 110. The neural network 405 is used to train the sentiment engine 410 to generate more accurate results.

An artificial neural network is a computer system architecture model that learns to do tasks and/or provide responses based on evaluation or “learning” from examples having known inputs and known outputs. A neural network features a series of interconnected nodes referred to as “neurons” or nodes. Input nodes are activated from an outside source/stimulus, such as input from the feedback/emotional history processor 230. The input nodes activate other internal network nodes according to connections between nodes (e.g., governed by machine parameters, prior relationships, etc.). The connections are dynamic and can change based on feedback, training, etc. By changing the connections, an output of the neural network can be improved or optimized to produce more/most accurate results. For example, the neural network 405 can be trained using information from one or more sources to map inputs to potential emotion outputs, etc.

Machine learning techniques, whether neural networks, deep learning networks, and/or other experiential/observational learning system(s), can be used to locate an object in an image, understand speech and convert speech into text, and improve the relevance of search engine results, for example. Deep learning is a subset of machine learning that uses a set of algorithms to model high-level abstractions in data using a deep graph with multiple processing layers including linear and non-linear transformations. While many machine learning systems are seeded with initial features and/or network weights to be modified through learning and updating of the machine learning network, a deep learning network trains itself to identify “good” features for analysis. Using a multilayered architecture, machines employing deep learning techniques can process raw data better than machines using conventional machine learning techniques. Examining data for groups of highly correlated values or distinctive themes is facilitated using different layers of evaluation or abstraction.

Deep learning that utilizes a convolutional neural network (CNN) segments data using convolutional filters to locate and identify learned, observable features in the data. Each filter or layer of the CNN architecture transforms the input data to increase the selectivity and invariance of the data. This abstraction of the data allows the machine to focus on the features in the data it is attempting to classify and ignore irrelevant background information.

Deep learning operates on the understanding that many datasets include high level features which include low level features. While examining an image, for example, rather than looking for an object, it is more efficient to look for edges which form motifs which form parts, which form the object being sought. These hierarchies of features can be found in many different forms of data such as speech and text, etc.

Learned observable features include objects and quantifiable regularities learned by the machine during supervised learning. A machine provided with a large set of well classified data is better equipped to distinguish and extract the features pertinent to successful classification of new data.

A deep learning machine that utilizes transfer learning may properly connect data features to certain classifications affirmed by a human expert. Conversely, the same machine can, when informed of an incorrect classification by a human expert, update the parameters for classification. Settings and/or other configuration information, for example, can be guided by learned use of settings and/or other configuration information, and, as a system is used more (e.g., repeatedly and/or by multiple users), a number of variations and/or other possibilities for settings and/or other configuration information can be reduced for a given situation.

An example deep learning neural network can be trained on a set of expert classified data, for example. This set of data builds the first parameters for the neural network, and this would be the stage of supervised learning. During the stage of supervised learning, the neural network can be tested whether the desired behavior has been achieved.

Once a desired neural network behavior has been achieved (e.g., a machine has been trained to operate according to a specified threshold, etc.), the machine can be deployed for use (e.g., testing the machine with “real” data, etc.). During operation, neural network classifications can be confirmed or denied (e.g., by an expert user, expert system, reference database, etc.) to continue to improve neural network behavior. The example neural network is then in a state of transfer learning, as parameters for classification that determine neural network behavior are updated based on ongoing interactions. In certain examples, the neural network can provide direct feedback to another process, such as the sentiment engine 410, etc. In certain examples, the neural network outputs data that is buffered (e.g., via the cloud, etc.) and validated before it is provided to another process.

In the example of FIG. 4, the neural network 405 receives input from the input processor 110, processes the technology 205, interaction 210, and/or other input and outputs a prediction or estimation of an overall emotional state of the users involved in the interaction. The prediction/estimation of overall emotional state can be a related word, numerical score, and/or other representation, for example. The network 405 can be seeded with some initial correlations and can then learn from ongoing experience. In some examples, the feedback generator 255 can provide feedback 140 by surveying users to obtain their opinion regarding suggestion(s), information, cue(s), etc., 250 provided the output generator 130. In other examples, the neural network 405 can be trained from a reference database or an expert user (e.g. a company human resources employee). The feedback 140 can be routed to the feedback/emotional history processor 230 to be fed into the training neural network 405. Once the neural network 405 reaches a desired level of accuracy (e.g., the network 405 is trained and ready for deployment), the sentiment engine 410 can be initialized and/or otherwise configured according to a deployed model of the trained neural network 405. In the example of FIG. 4, throughout the operational life of the emotion detection engine 220, the neural network 405 is continuously trained via feedback and the sentiment engine 410 can be updated based on the neural network 405 and/or gathered emotional data 415 as desired. The network 405 can learn and evolve based on role, location, situation, etc.

In certain examples, the sentiment engine 410 processes available information (e.g., text messages on a work phone, social media posts made public, transcripts generated from captured phone conversations, other messages, etc.) combined with other factors such as participant relationship extracted from a management system, and/or other workplace context that impacts the emotion determination (e.g., culture, time zone, particular workplace, etc.). The neural network 405 can be used to model these components and their relationships, and the sentiment engine 410 can leverage these connections to resulting output. Thus, artificial intelligence can be leveraged by the sentiment engine 410 for a specific industry, culture, team, etc. The sentiment engine 410 leverages the information and integrates information from multiple systems to generate potential emotion results. In certain examples, location, role, situation, etc., can be weighted differently in calculating and/or otherwise determining appropriate emotion(s). For example, a typical stress and/or typical response to a given situation can be modeled using the deployed network 405 and/or other digital twin modeling personalities, types, situations, etc.

The example potential emotions identifier 225, using the output of the neural network 405 and the sentiment engine 410, can then narrow down possible emotions to determine a subset (e.g., two, three, four, etc.) of most likely emotions to be exhibited and/or otherwise impact an interaction. The subset of most likely emotions 420 is outputted to an emotional, relational, and situational context comparator 425 to determine a most likely emotion(s) and output this information to the communication suggestion engine 235, for example. In some examples, the subset of most likely emotions can be output to a user and, then, based on user selection(s), specific output communication suggestions can be provided. The comparator 425 compares each of the subset of most likely emotions 420 with emotional, relational, and/or situational context (as well as user selection as noted above) to determine which emotion(s) 420 is/are most likely to factor into the interaction.

In certain examples, emotions that can be detected include frustration, busy (e.g., from many meetings, etc.), overworked/overwhelmed, outside of work concern, work-related concern, health-related concern, work-related happiness, outside of work happiness (e.g., “excited to share”, etc.), distant, scared (e.g., based on layoff rumors, etc.), new, seasoned, rage, etc.

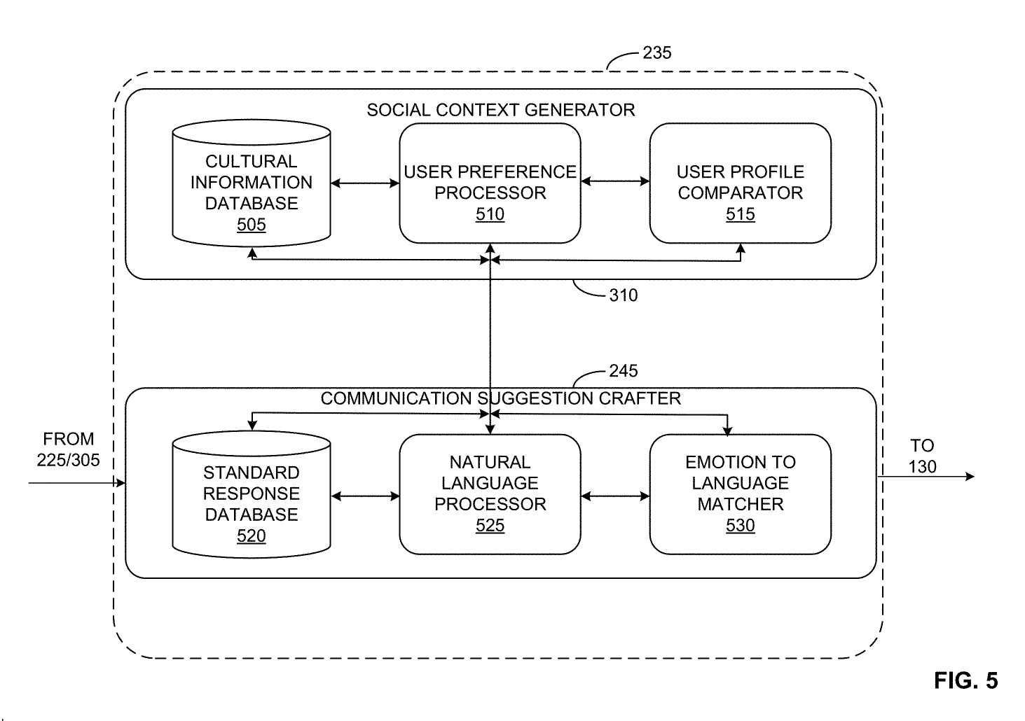

FIG. 5 illustrates an example implementation of the communication suggestion engine 235 and its communication suggestion crafter 245 and social context generator 310. In the example of FIG. 5, the communication suggestion engine 235 uses the social context generator 310 to determine a social context of the interaction. In the example of FIG. 5, the social context determiner 310 includes a cultural information database 505, a user preference processor 510, and a user profile comparator 515. The cultural information database 505 is a database including information relating to cultural influences in communication. For example, if a user profile indicates that user is from the American south, the cultural database 505 provides a correlation to local vernacular for the emotional communication suggestion crafter 240 to replace “you all” with “y' all.” For another example, if the user is within a certain microculture (e.g., teenagers who use Snapchat™, etc.), then additional specific vernacular can be loaded into the database 505. There are many cultures, subcultures, and microcultures around the world that can be taken into account using the cultural database 505.

In some examples, the user preference processor 510 processes user profile information provided from the input processor 110 (e.g., via the potential emotion identifier 225 and/or the emotional context generator 305, etc.) to determine which elements of a user's profile are relevant to the interaction. For example, the processor 510 may recognize a relevant portion of user's cultural background and notify the cultural database 505 (e.g. the user and/or another participant is from the American South., etc.). In other examples, a user's preference may note that they prefer to be called by a nickname instead of their given name.

In some examples, the user profile comparator 515 compares the profile information of participants in an upcoming, ongoing, and/or other potential interaction to look for potential points of agreement, conflict or topics of conversation. For example, the comparator 515 may recognize that two participants (e.g., the user and another participant, etc.) have recently encountered a shared non-personal issue (e.g. a manager has issued new, more strict, document guidelines, etc.). In other examples, the comparator 515 notes that all participants are fans of the same professional sports team. In other examples, the comparator 515 notes that two participants are fans of opposing sports teams. In some examples, the comparator 515 includes a neural network and/or other machine learning framework. In other examples, the comparator 515 processes and compares participant profile information using one or more algorithms based off a list of potential points of comparison or another suitable architecture. In the above examples, the user profile comparator 515 provides its comparisons to the communication suggestion crafter 245.

In the example of FIG. 5, the communication suggestion crafter 245 receives information from the social context generator 310 (and/or, more generally, the relational context identifier 240 of FIG. 2) and output from the emotion detection engine 220. The communication suggestion crafter 245 then uses an emotion-to-language matcher 530 to determine what sort of language is to be output to the user. For example, the emotion-to-language matcher 530 receives the emotion “sad” from the emotion detection engine 220, and the emotion-to-language matcher 530 factors in the social and emotional context with the emotion of “sad” to suggest consolatory or sympathetic language to the user (e.g., to be output via smart phone, smart watch, tablet, earpiece, glasses, etc.).

In some examples, the suggested phrases are crafted dynamically (e.g. “on-the-fly”, etc.) using a natural language processor (NLP) 525. The NLP technology allows the processor 525 to translate normal computer logical language into something a layperson can understand. In other examples, suggested phrases are generated from a database of standard responses 520. For example, the database 520 may include ten “standard entries” selected based on emotion and relationship of parties involved in the interaction. Each emotion may have one hundred possibilities for a “standard” response, for example. Using the social context 310 and emotional context 305, the suggestion crafter 245 can reduce the set of applicable possibilities to select a subset (e.g., three, ten, etc.) most relevant responses. Alternatively, or in addition, the suggestion crafter 245 takes suggestions from the response database 520 based on user profile preferences from the user preference processor 510 (e.g., alone or in conjunction with input from the cultural information database 505 and/or the user profile comparator, etc.) to determine a subset of relevant responses.

Thus, for example, the system 100 can process available information (e.g., with respect to individuals involved in an upcoming interaction, appointment, etc.) and provide interaction suggestions (e.g., via augmented reality, smart phone/tablet feedback, etc.) considering participant relationship, circumstances, and/or other emotional context of the interaction. Thus, for example, if the user is merely passing by an employee that the user is not well acquainted with, the user can be provided with information reminding the user of the employee's name and prompting the user to congratulate the employee on his or her promotion. Alternatively, or in addition, if the user is meeting with an employee to discuss improving the employee's performance, the user can be provided with auxiliary information that highlights some important past performance statistics.

In one example general use case, Susan leaves her office and walks to a meeting with Deepa. As Susan walks into the meeting, her phone vibrates. The output generator 130 provides suggestions to Susan's smart phone based on information from the input processor 110 regarding Susan and Deepa's relationship, Deepa's recent activity, calendar/scheduling content, etc., as processed by the emotional intelligence engine 120 to provide Susan with appropriate comments based on the relationship information, interaction context, etc. A new text message includes suggestions for the interaction: “Jam-packed schedule lately?”, “How was your recent trip to Barbados?”, “What do you think of the new simplification guidelines?”, etc. Susan chooses one or none, and then the system 100 records the feedback/quality/emotions 140 of the situation via the feedback generator 255 capturing Susan's input and/or other monitoring of the encounter.

More specifically, the digital workplace technology compiler 205 and/or digital personal technology compiler 215 determines that Deepa had seven meetings the day before and might feel “busy”, prompting the communication suggestion crafter 240 to suggest “Jam-packed schedule lately?” Alternatively or in addition, the digital workplace technology compiler 205 and/or digital personal technology compiler 215 determines that Deepa had blocked off her calendar two weeks ago with the title “Barbados Trip”, and the relational context identifier 240 (e.g., based on interaction detector 210 input, historical data, etc.) determines that the relational context of Susan and Deepa includes outside of work discussions and Deepa might feel “excited to share”, thereby prompting a suggestion of “How was your recent trip to Barbados?” Alternatively, or in addition, the digital personal technology compiler 215 can be aware of the working relationship between Susan and Deepa as well as a general department-related initiative (e.g. “simplification guidelines”, etc.) that is not specific to the relationship of the individuals. Their interaction might feel “distant”, but talking about a common, shared non-personal issue (e.g., “What do you think of the new simplification guidelines?”, etc.) may help to close the emotional gap.

In another example use case for a hospital administrator, Hospital Manager Cory manages fifteen sites and one thousand six hundred people. He is walking down the hall in one of his facilities and walks by an employee he does not know. His Augmented Reality glasses display some context-relevant information to him and provide him with some potential conversation prompts by identifying the employee as Jenna Strom, whose been working there for only three weeks with an emergency room (ER) nursing specialty. The output generator 130 processes this information and provides suggestions for interaction such as: “Are you Jenna, the new nurse on our ER team? Welcome!”; “Hi Jenna! I'm Cory, the Hospital Manager, how are you liking your time here so far?”; etc. Cory may select one of these suggestions or determine a hybrid comment on his own to engage Jenna.

In the above example, the digital personal technology compiler 215 and/or digital workplace technology compiler 205 can detect Cory's location in the building and identify who is around him (e.g., using RFID, beacons, badge access, smartphones, etc.). Location information is combined with hospital human resources (HR) data and/or other workforce management information by the potential emotions identifier 225. In certain examples, a level of access to personnel information can be filtered based on user permission status, etc. Then, the potential emotions identifier 225 identifies an emotion related to the potential target (e.g., a “new” instead of “seasoned” employee feeling, etc.) and then provides potential statistics and dialog options particular to that individual and emotion.

In another example use case involving emotional de-escalation, suggestions can be determined and provided to people at odds in a team-based environment. Detecting such workplace friction and generating ways to improve relationships for the betterment of the team can be helpful. For example, an instant messaging program identifies Marsha complaining a lot about something Francine said. Additionally, an HR management system locates formal complaints that Francine has filed regarding Marsha. The workplace interaction detector 210 notices that they have been placed on the same project team (e.g., based on meeting invites, project wiki list, etc.). The potential emotions identifier 225 determines a likely emotion of “dislike” or “distrust” or “friction” resulting from the interaction, and the communication suggestion crafter 245 works with the output generator 130 to generates specific communication suggestions to Marsh, Francine, the project manager, and or their HR managers, for example.

In another example use case, the example system 100 generates reminders following an interruption or other disruption. For example, a nurse is going to appointment with a patient and is in a good mood. However, the nurse has an interruption (e.g., from a manager about hours worked, etc.) and/or other disruption (e.g., a medical emergency, etc.). Following the interruption/disruption, the output generator 130 provides a reminder to the nurse to be kind/cheerful before walking in to see the patient. The digital technology suggestion output 255 can provide a reminder of specific needs for the specific patient (e.g., “doesn't like needles”, “needs an interpreter”, “patient waiting 20 minutes, gentle apology”, etc.). Thus, the digital personal technology compiler 215 and/or the digital workplace technology compiler 205 can access an EMR and update the EMR with personal/emotional preferences, while also automatically detecting when an appointment is scheduled and if the doctor/nurse is late (e.g., based on a technology comparison of employee location within the building and employee scheduled location, etc.) to help the emotion detection engine 220 and communication suggestion engine 235 provide reminders via the output generator 130 to the nurse.

In another example use case providing real-time emotional feedback during a meeting and/or other interaction, Brian is in a meeting, and the digital personal technology compiler 215 identifies that Brian is in a good mood. However, as the speaker presents, Brian gets bored or annoyed. The output generator 130 can provide the speaker with an in process cue indicating Brian's mood, along with a suggestion to “be more lively”, “move on to new subject”, “we advise a stretch break”, “we have already ordered donuts and they are on the way because you are boring your audience”, and/or “fresh coffee is being brewed”, etc. Thus, the digital personal technology compiler 215 and/or the digital workplace technology compiler 205 can detect Brian's heart rate, facial expressions (e.g., via telepresence camera, etc.), frequency of checking email/phone, work on another email or conversation on mute (e.g., in a remote WebEx™ meeting, email in draft, etc.) to allow the potential emotions identifier 225 to determine that Brian is distracted. The communication suggestion crafter 245 can generate appropriate cues, suggestions, etc., for Brian via the digital technology output 250, for example. This can positively improve many of the lectures and presentations in education environments, for example.

In another example use case involving a hospital clinician, an ability to detect patient status and help the clinical with his/her bedside manner (e.g., for doctors on rounds or in primary care facility, etc.) helps to enable better connection between patient and clinician over time, resulting in improved patient and clinician satisfaction and outcome.

While example implementations of the system 100 are illustrated in FIGS. 1-5, one or more of the elements, in certain examples, processes and/or devices illustrated in FIGS. 1-5 may be combined, divided, re-arranged, omitted, eliminated and/or implemented in any other way. Further, the example input processor 110, the example emotional intelligence engine 120, the example output generator 130, and/or, more generally, the example system 100 of FIGS. 1-5 may be implemented by hardware, software, firmware and/or any combination of hardware, software and/or firmware. Implementations can be distributed, cloud-based, local, remote, etc. Thus, for example, any of the example input processor 110, the example emotional intelligence engine 120, the example output generator 130, and/or, more generally, the example system 100 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example input processor 110, the example emotional intelligence engine 120, the example output generator 130, and/or the example system 100 is/are hereby expressly defined to include a non-transitory computer readable storage device or storage disk such as a memory, a digital versatile disk (DVD), a compact disk (CD), a Blu-ray disk, etc. including the software and/or firmware. Further still, the example system 100 of FIGS. 1-5 may include one or more elements, processes and/or devices in addition to, or instead of, those illustrated in FIGS. 1-5, and/or may include more than one of any or all of the illustrated elements, processes and devices.

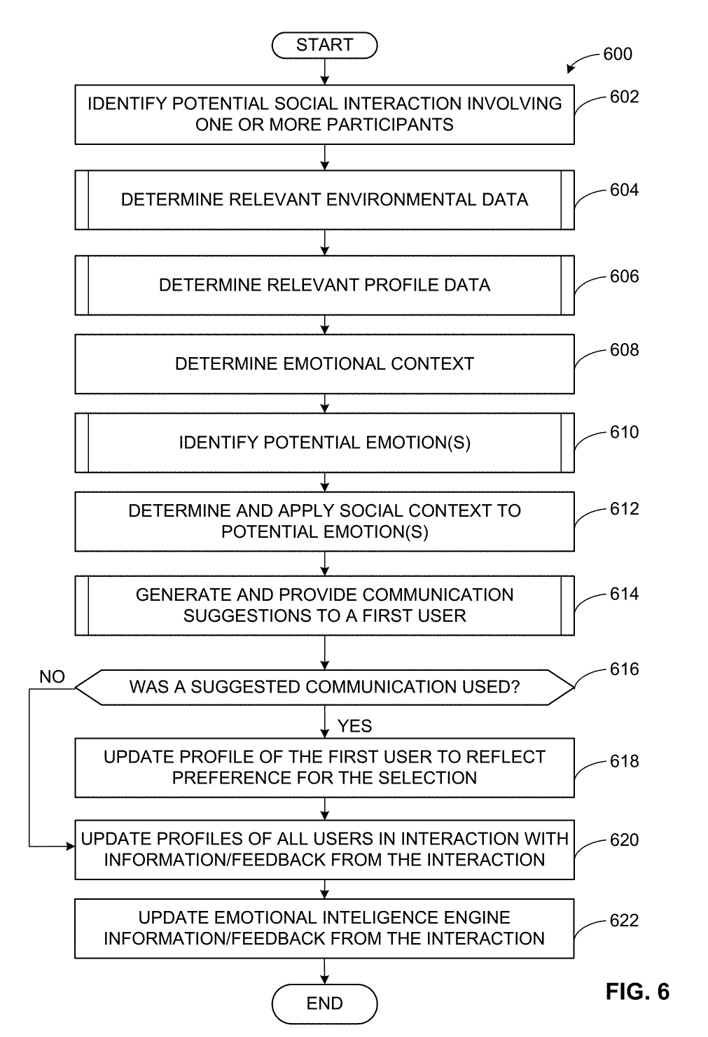

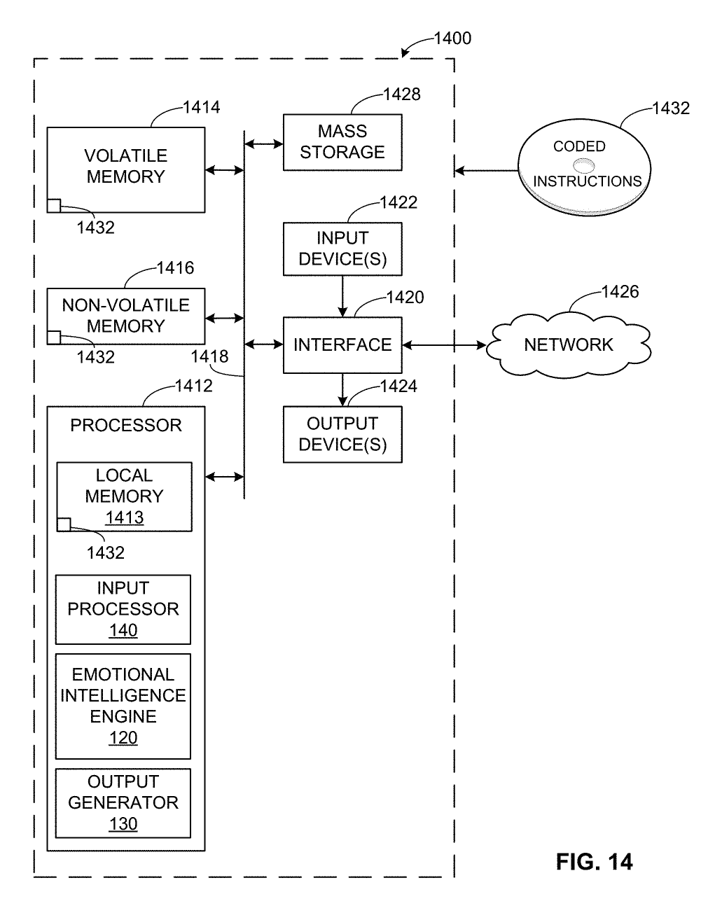

Flowcharts representative of example machine readable instructions for implementing the system 100 of FIGS. 1-5 are shown in FIGS. 6-10. In these examples, the machine readable instructions include a program for execution by a processor such as a processor 1412 shown in the example processor platform 1400 discussed below in connection with FIG. 14. The program may be embodied in software stored on a non-transitory computer readable storage medium such as a CD-ROM, a floppy disk, a hard drive, a DVD, a Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowcharts illustrated in FIG. 6-10, many other methods of implementing the example apparatus 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 6-10 may be implemented using coded instructions (e.g., computer and/or machine readable instructions) stored on a non-transitory computer and/or machine readable medium such as a hard disk drive, a flash memory, a read-only memory, a CD, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open ended in the same manner as the term “comprising” and “including” are open ended.

FIG. 6 illustrates a flow diagram showing an example method 600 for generating interaction suggestions based on gathering of emotional and relational context information and identifying potential emotions impacting the interaction. At block 602, the interaction detector 210 detects a potential interaction between one or more people. For example, detection may be facilitated using RFID tags, beacons, motion detection, video detection, etc. In other examples, potential interaction is detected by monitoring associated scheduling application(s) (e.g. Microsoft Outlook, Gmail™, etc.), social media posting(s), and/or non-verbal communication, etc. The presence of this potential interaction is then provided to block 604.

At block 604, relevant environmental data is determined. For example, information regarding location, time, organizational relationship, biometric data, etc., can be gathered as the information applies to the potential interaction and/or the likely participants.

At block 606, relevant profile data is determined. For example, schedule information, workplace communication records, participant relationship information, etc., can be gathered as the information applies to the potential interaction and/or likely participants.

At block 608, using the relevant environmental data output from block 604 and the relevant profile data from block 606, an emotional context of the interaction is determined by the emotional context generator 305. For example, if the emotion context generator 305 identifies that a user had seven meetings in one day, it can generate an emotional context indicating that the user may feel “busy” or “overwhelmed.” In another example, when given information about a user's heart rate, facial expressions and other related biometrics, the emotional context generator 305 can indicate that user may feel “bored.” In another example, the emotional context generator may note that a user was recently hired and can indicate that that user may feel “new.” This emotional context can then be output to block 610.

At block 610, the potential emotion identifier 225 identifies one or more potential emotion based on the available data (e.g., environmental, profile, etc.) and emotional context. The potential emotion identifier 225 can leverage emotional history for one or more participants and/or other feedback from the processor 220 as well as the emotional context from the emotional context generator 305 to provide possible emotions for one or more participants in the interaction. For example, a person just finishing a twelve-hour shift is likely to be one or more of tired, irritable, angry, sad, etc. A person starting a new job is likely to be eager, excited, nervous, motivated, etc.

In certain examples, the potential emotions identifier 225 can filter out lower probability emotions in favor of higher probability emotions based on one or more of the following. For example, past history may receive a higher weight because people do not tend to change their emotional habits very often. Higher weight can be assigned to more recent comments rather than older comments made by a participant. Higher weight can be given to comments that are made to a person's close friend/advisor. For example, a person may have one or two close friends at work with whom they share honestly. Communications with close friends that include emotional context generally are weighted higher by the identifier 225. In some examples, if an emotion cannot be exactly pinpointed, a range of green, yellow, red, and/or other indicators showing a general attitude can be provided a fallback position. For example, if a participant has less data and history in the system 100, a general attitude may be better predicted than a particular emotion, and the analysis can improve over time as more data, history, and interaction are gathered for that person.

At block 612, using the relevant environmental data outputted from block 604 and the relevant profile data from block 606, a social context of the interaction can be determined by the social context generator 310. For example, when given an input that two coworkers have never interacted with one another, the social context generator 310 may note the context between the two is “distant” and “awkward.” In another example, the social context generator 310 may notice that one participant has filed a human resources complaint about another participant and generate a “dislike,” “distrust,” or “friction” social context. In another example, the social context generator 310 notes that a healthcare professional was interrupted while interacting with a patient, and notes (to the healthcare professional), the context is “interrupted” or “apologetic.”

At block 614, using the emotional and social contexts in conjunction with the potential emotions identified at block 610, the communication suggestion engine 235 crafts communication suggestions for a user. For example, the social context provided at block 612 can be applied by the communication suggestion crafter 245 to reduce potential emotions to a likely subset of potential emotions (e.g., one, two, three, etc.). The communication suggestion crafter 245 can leverage a library or database (e.g., the standard response database 520) that can be improved by machine and/or other artificial intelligence as more interactions occur. Suggestions from the database 520 can be filtered based on one or more of a cultural context, locational context, relational context, etc. The crafter 245 provides corresponding communication suggestion(s) for each of the subset of potential emotions (e.g., providing an observational comment, an appropriate greeting, a suggestion on user behavior/attitude, etc.). The suggestions(s) are provided to the user via the output generator 130 (e.g., to leverage digital technology to output 250 via smart watch, smart phone, smart glasses, tablet, earpiece, etc.).

At block 616, the feedback generator 140 determines whether or not the user used a communication suggestion from the communication suggestion engine 235. In one example, the determination is done passively, by recording the interaction between the participants and using NLP to determine if the user communicated with a suggested communication. In other examples, the determination is done with active feedback from the user. In this example, the user indicates through a user interface which communication suggestion they selected.

If the user used a communication suggestion suggested by the communication suggestion engine 235, then, at block 618, the user's profile information is updated to reflect this selection. For example, if the user shows a preference for less formal communication, their profile is updated to show this preference.

At block 620, the profiles of all participants involved in the interaction are updated with the results of this interaction. For example, feedback and/or other input gleaned by the feedback generator 255 can be used to update user and/or other participant profiles (e.g., monitored behavior, success or failure of the interaction, preference(s) learned, etc.).

At block 622, the emotional intelligence engine 120 is updated based on feedback from the interaction. For example, the feedback generator 255 captures information from the interaction and provides feedback 140 to the feedback/emotional history processor 230, which is used to update performance of the potential emotion identifier 225 in subsequent operation.

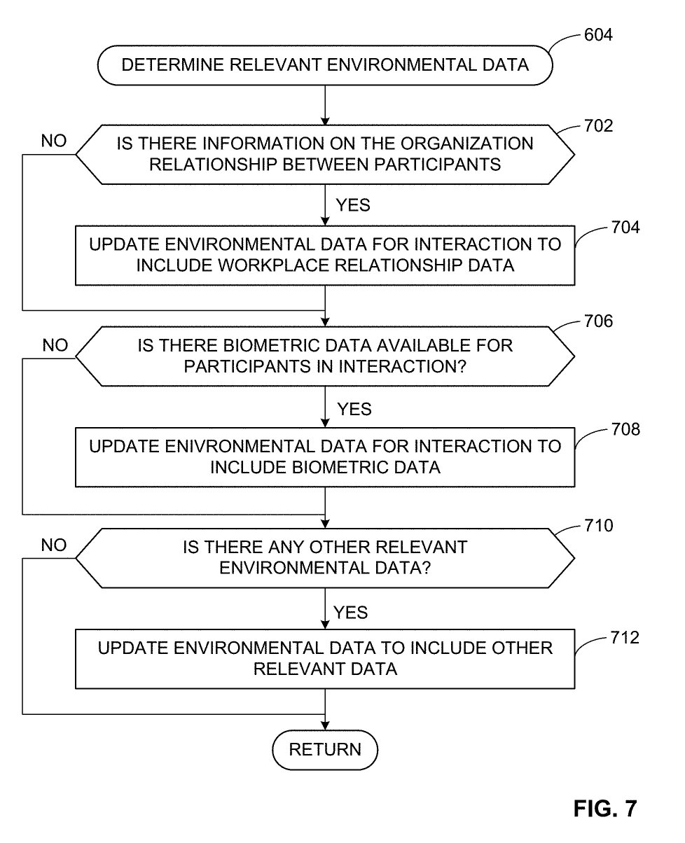

FIG. 7 provides further detail regarding an example implementation of block 604 to determine relevant environmental data for a potential interaction in the example method 600 of FIG. 6. If present, environmental data can be gathered including location, time, individual(s) present, etc., with respect to the interaction. At block 702, available information (e.g., from the digital workplace technology compiler 205, digital personal technology compiler 215, etc.) regarding an organizational relationship between participants is identified. If information is available (e.g., the user is the participant's boss, the participant is the user's manager, the user and other participant(s) work in the same department, etc.), then, at block 704, environmental data is updated to include the workplace/organizational relationship information.

At block 706, available information is evaluated to determine whether biometric information is available for one or more participants in the potential interaction. If biometric information is available (e.g., heart rate, facial expression, tone of voice, etc.), then, at block 708, environmental data is updated to include the biometric information.

At block 710, the availability of other relevant environment data is evaluated. For example, other relevant environment data may include location information, time data, and/or other workplace factors. If additional environmental data is available, then, at block 712, the other relevant environmental data is used to update the set of environmental data. The process then returns to block 606 to determine relevant profile data.

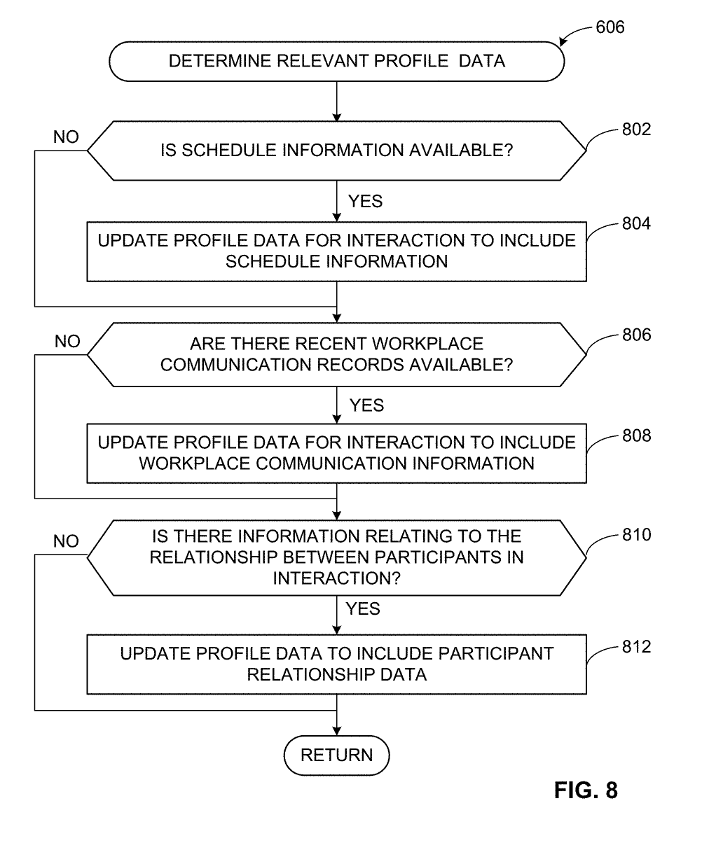

FIG. 8 provides further detail regarding an example implementation of block 606 to determine relevant profile data for participants in a potential interaction in the example method 600 of FIG. 6. If available, profile data can be updated for a potential interaction to include user and/or other participant information, preference, etc.

At block 802, available schedule information for the user and/or other interaction participant is identified. If schedule information (e.g., upcoming appointment(s), past appointment(s), vacation, doctor visit, meeting, etc.,) is available, then, at block 804, profile data is updated to include schedule information for the user and/or other participant(s) in the potential interaction.

At block 806, available workplace communication records are identified for inclusion in the profile data for emotion analysis. For example, emails, letters, and/or other documentation regarding job transfers, personnel complaints, performance reviews, meeting invitations, meeting minutes, etc., can be identified to provide profile information to support the determination of potential emotions involved with participants in an interaction. If workplace communication information is available, then, at block 808, the profile data for the interaction is updated to include the workplace communication information.

At block 810, available information regarding relationship(s) between participants in the potential interaction is identified for inclusion in the profile data. For example, relationship information such as manager-employee relationship information, friendship, family relationship, participation in common events, etc., may be available from workforce management systems, social media accounts, calendar appointment information, email messages, contact information records, etc. If participant relationship is available, then, at block 812, the profile data for the interaction is updated to include the participant relationship information. Control then returns to block 608 to determine an emotional context for the potential interaction.

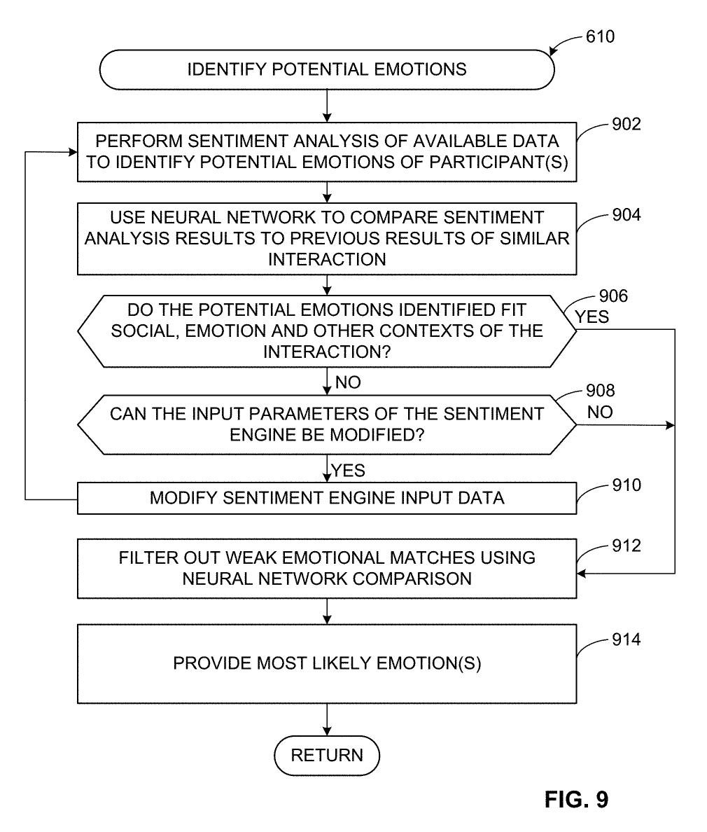

FIG. 9 provides further detail regarding an example implementation of block 610 to identify potential emotions by the potential emotion identifier 225 in the example method 600 of FIG. 6. For example, relational, situational, and/or emotional context can be compared to a “typical” context of interaction to identify potential emotion(s) for participant(s) in an interaction. At block 902, the sentiment engine 410 performs a sentiment analysis using the available data to identify potential emotions of one or more participants involved or potentially soon to be involved with the user in an interaction. For example, the sentiment engine 410 processes feedback and/or other emotional history information from the processor 230 as well as input provided by the digital workplace technology compiler 205, the interaction detector 210, and/or the digital personal technology compiler 215 of the input processor 210 to generate a plurality of potential emotions for participant(s) in the interaction. Emotional context from the context generator 305 also factors in to the sentiment engine's 410 analysis.

At block 904, the neural network 405 (e.g., a deployed version of the trained neural network 405) can be leveraged compare the potential emotion results of the sentiment engine 410 with prior results of similar emotional analysis as indicated by the output(s) of the neural network 405. At block 906, the sentiment engine 410 emotion possibilities are evaluated to determine whether they fit with prior emotional, relational, situational, and/or other contexts for this and/or similar interaction(s).

If not, then, at block 908, sentiment engine 410 parameters are evaluated to determine whether the parameters can be modified (e.g., via or based on the neural network 405). If sentiment engine 410 parameters can be modified, then, at block 910, input to the sentiment engine 410 is modified and control reverts to block 902 to perform an updated sentiment analysis. If sentiment engine 410 parameters cannot be modified and/or the potential emotions did fit the context(s) of the potential and/or other similar interaction(s), then, at block 912, the potential emotions provided by the sentiment engine 410 are filtered (e.g., reduced, etc.) to eliminate “weak” or lesser emotional matches. For example, the neural network 405, matching algorithm, and/or other bounding criterion(-ia) can be applied to reduce the set of potential emotions provided by the sentiment engine 410 to a subset 420 best matching the context(s) associated with the interaction and its participant(s). The context comparator 425 can process the subset of most likely emotions (e.g., two, three, five, etc.) to determine a most likely emotion(s) by comparing each emotion in the subset of most likely emotions 420 with emotional, relational, and/or situational context to determine which emotion(s) 420 is/are most likely to factor into the interaction.

In certain examples, the potential emotions identifier 225 can filter out lower probability emotions in favor of higher probability emotions based on one or more of the following. For example, past history may receive a higher weight because people do not tend to change their emotional habits very often. Higher weight can be assigned to more recent comments rather than older comments made by a participant. Higher weight can be given to comments that are made to a person's close friend/advisor. For example, a person may have one or two close friends at work with whom they share honestly. Communications with close friends that include emotional context generally are weighted higher by the identifier 225. In some examples, if an emotion cannot be exactly pinpointed, a range of green, yellow, red, and/or other indicators showing a general attitude can be provided a fallback position. For example, if a participant has less data and history in the system 100, a general attitude may be better predicted than a particular emotion, and the analysis can improve over time as more data, history, and interaction are gathered for that person.

At block 914, the most likely emotion(s) are provided, and control returns to block 612 to determine and apply social context to the most likely potential emotion(s).

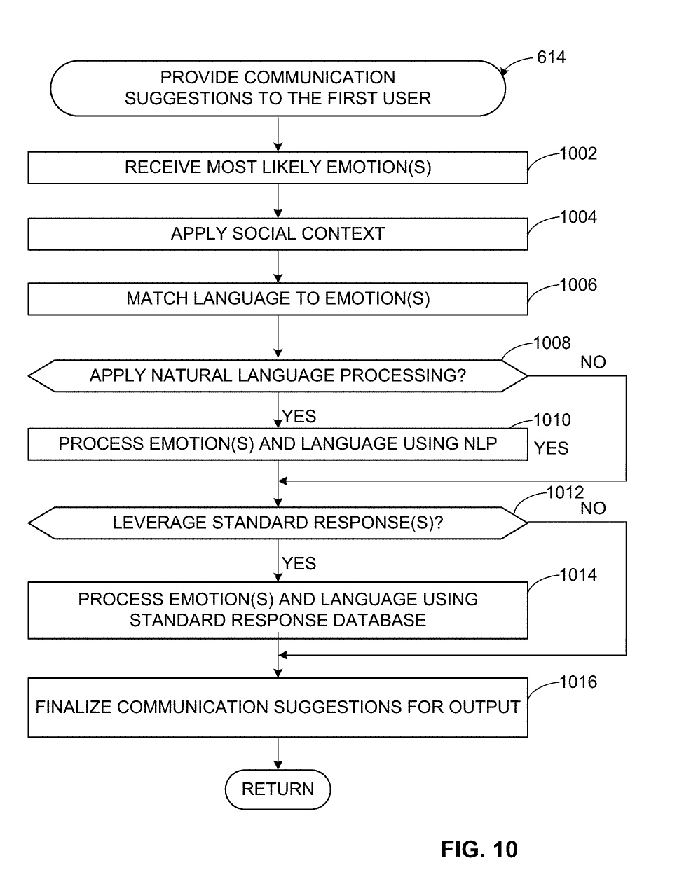

FIG. 10 provides further detail regarding an example implementation of block 614 to generate and provide communication suggestions to a first user for the potential interaction in the example method 600 of FIG. 6. For example, potential emotion(s) provided by the identifier 225 are processed by the suggestion crafter 245 to generate and provide communication suggestions to the first user of the system 100. At block 1002, the most likely emotion(s) are received by the communication suggestion crafter 245 from the potential emotion identifier 225. At block 1004, social context is applied to those emotion(s). For example, cultural information, user preference, profile information, etc., are combined by the social context generator 310 and used to provide a social context to the emotion(s) most likely to factor into the upcoming interaction.

At block 1006, language is matched to the emotion(s) by the emotion-to-language matcher 530. For example, the matcher 530 processes the emotion(s) in their social context and generates suggested language associated with the emotion(s). Thus, for example, an emotion of nervousness and new in the social context of a new employee preparing for her first presentation can be matched with language of encouragement to provide to the new employee.

At block 1008, the language, settings, preferences, etc., are evaluated to determine whether natural language processing is available and should be applied. For example, the natural language processor 525 may be available, and the suggested language may be in the form of key words, tags, ideas, etc., that can be converted into more natural speech using the processor 525. If so, then, at block 1010, the natural language processor 525 processes the language. In certain examples, the processor 525 can provide feedback and/or otherwise work with the matcher 530 to generate suggested speech.

At block 1012, the language, settings, preferences, etc., are evaluated to determine whether standard responses are available and should be applied. For example, the standard response database 520 may be available, and the suggested language may be in the form of key words, tags, ideas, etc., that can be converted into more natural speech using the standard response database 520. If so, then, at block 1014, the database 520 is used to lookup wording for response based on language from the emotion-to-language matcher 530. In certain examples, rather than or in addition to spoken language, an indication of a response (e.g., a mood, a warning, a reminder, etc.) can be provided in terms of a sound, a color, a vibration, etc.

At block 1016, communication suggestions are finalized for output. For example, suggested communication phrase(s), audible/visual/tactile output, and/or other cues are finalized by the communication suggestion crafter 245 and sent to the output processor 130 to be output to the user (e.g., via text, voice, sound, visual stimulus, tactile feedback, etc.). For example, one or more communication suggestions can be output to the user via digital technology 250. For example, the user can be prompted with a single communication suggest, with a suggestion per likely emotion (e.g., with three likely emotions come three possible outputs for suggested communication, etc.), with a selected emotion that is more helpful to the employer (e.g., to keep employees on task rather than socialization for too long, etc.), etc. In an example, when attempting to de-escalate a situation, a de-escalation factor can promote a communication suggestion that might otherwise be outweighed by other choices but is currently important to de-escalate the situation.

In certain examples, if the output digital technology 250 includes one or more self-monitoring devices, such as a smart watch, heart rate monitor, etc., the user's physical response (e.g., heart rate, blood pressure, etc.) can be monitored and breathing instructions, calming instructions, etc., can be provided to the user to help the user stay calm in more critical situations.

Control reverts to block 616 to evaluate whether any suggest was used in the interaction.

In certain examples, the system 100 can be used to help improve police interaction with one or more participants. For example, a police officer may be wearing a body camera. The system 100 (e.g., using the input processor 110) can determine information about the relevant neighborhood, people involved (e.g., using facial recognition, driver's license scan, etc.), and provide the officer with helpful (and legally useful) suggestions via the output generator 130. Such suggestions can be useful to help ensure the police officer asks the right questions to determine admissible evidence, for example. The system 100 may know more than the officer could ever know and can provide specific suggestions to solve crimes quicker and provide respectful suggestions in interacting with users. The officer's body camera can record the interactions to provide feedback 140, as well.

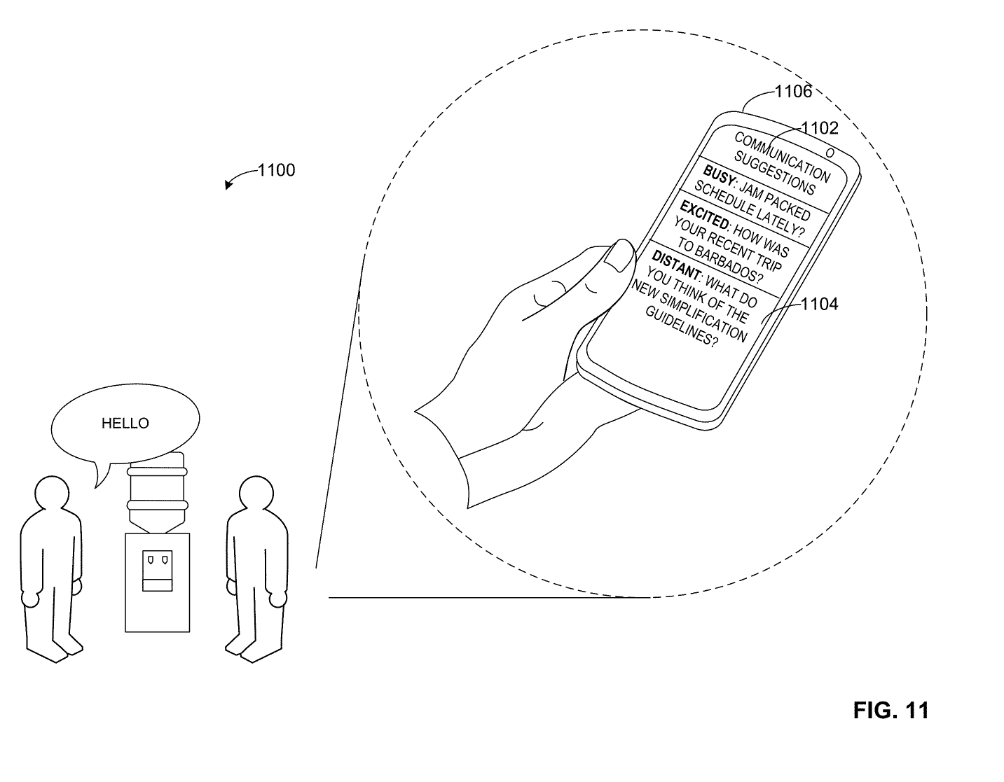

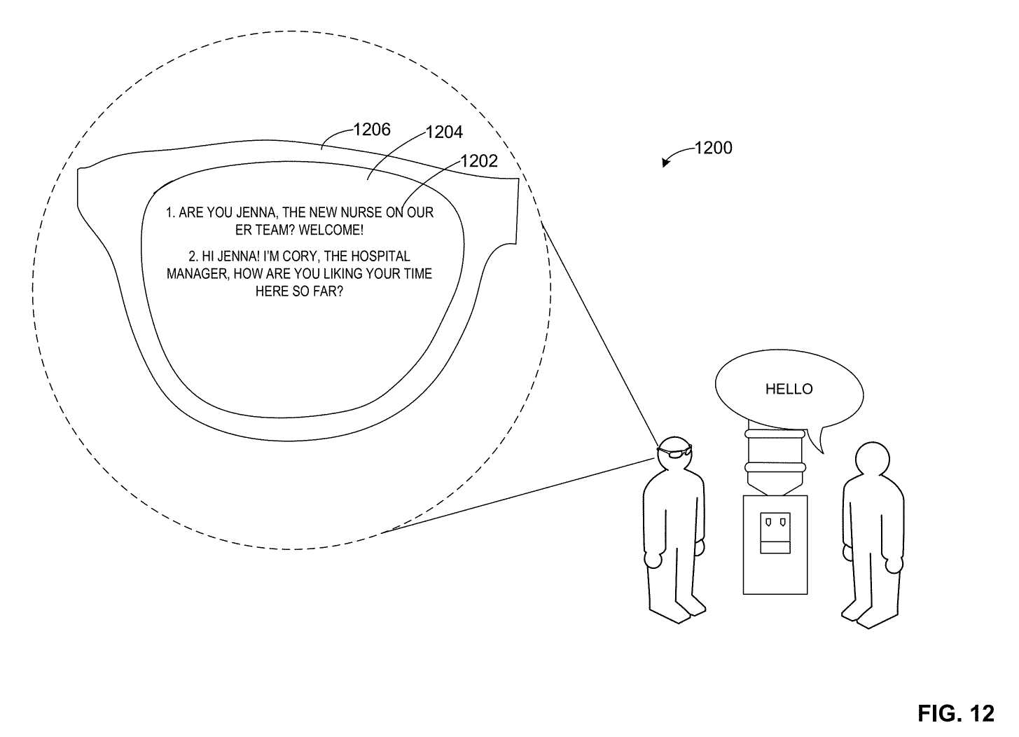

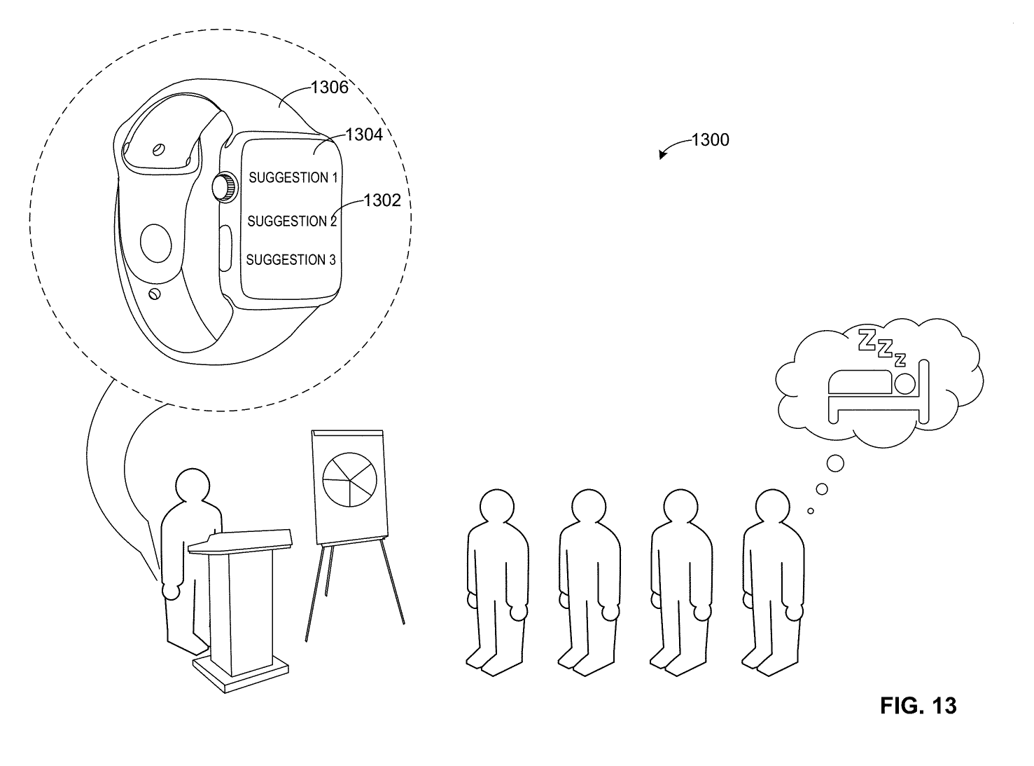

FIGS. 11-13 illustrate example output provided via digital technology 250 to a user. FIG. 11 illustrates an example output scenario 1100 in which the user is provided with a plurality of communication suggestions 1102 via a graphical user interface 1104 on a smartphone 1106. FIG. 12 depicts another example output scenario 1200 in which the user is provided with a plurality of communication suggestions 1202 via a projection 1204 onto or in glasses and/or other lens(es) 1206. FIG. 13 shows another example output scenario 1300 in which the user is provided with a plurality of communication suggestions 1302 via a graphical user interface 1304 on a smartwatch 1306.

Thus, certain examples facilitate parsing of historical data, personal profile data, relationships, social context, and/or other data mining to correlate information with likely emotions. Certain examples leverage the technological determination of likely emotions to craft suggestions to aid a user in an interaction with other participant(s), such as by reminding the user of potential issue(s) with a participant, providing suggested topic(s) of conversation, and/or otherwise guiding the user in strategy(-ies) for interaction based on rules-based processing of available information.

Certain examples help alleviate mistakes and improve human interaction through augmented reality analysis and suggestion. Certain examples process feedback to improve interaction suggestion(s), strengthen correlation(s) between emotions and suggestions, model personalities (e.g., via digital twin, etc.), improve timing of suggestion(s), evaluate impact of role on suggestion, etc. Machine learning can be applied to continue to train models, update the digital twin, periodically deploy updated models (e.g., for the sentiment engine 410, etc.), etc., based on ongoing feedback and evaluation.

FIG. 14 is a block diagram of an example processor platform 1400 structured to executing the instructions of FIGS. 6-10 to implement the example components disclosed and described herein (e.g., in FIGS. 1-5 and 11-13). The processor platform 1400 can be, for example, a server, a personal computer, a mobile device (e.g., a cell phone, a smart phone, a tablet such as an iPad™), a personal digital assistant (PDA), an Internet appliance, or any other type of computing device.

The processor platform 1400 of the illustrated example includes a processor 1412. The processor 1412 of the illustrated example is hardware. For example, the processor 1412 can be implemented by integrated circuits, logic circuits, microprocessors or controllers from any desired family or manufacturer.

The processor 1412 of the illustrated example includes a local memory 1413 (e.g., a cache). The example processor 1412 of FIG. 14 executes the instructions of at least FIGS. 6-10 to implement the systems and infrastructure and associated methods of FIGS. 1-13, including the input processor 110, emotional intelligence engine 120, and output generator 130. The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a clock controller.

The processor platform 1400 of the illustrated example also includes an interface circuit 1420. The interface circuit 1420 may be implemented by any type of interface standard, such as an Ethernet interface, a universal serial bus (USB), and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1420 of the illustrated example, thus, typically includes a graphics driver card, a graphics driver chip or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a digital subscriber line (DSL), a telephone line, coaxial cable, a cellular telephone system, etc.).

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and digital versatile disk (DVD) drives.

The coded instructions 1432 of FIG. 14 may be stored in the mass storage device 1428, in the volatile memory 1414, in the non-volatile memory 1416, and/or on a removable tangible computer readable storage medium such as a CD or DVD.

From the foregoing, it will be appreciated that the above disclosed methods, apparatus, and articles of manufacture have been disclosed to monitor, process, and improve evaluation of available information to extract involved emotions and provide automated suggestions to aid in interactions using machine learning, sentiment analysis, and correlation among a plurality of disparate systems in particular emotional, social, and relational contexts.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. An apparatus comprising:
a memory to store instructions; and
a processor to be particularly programmed using the instructions to implement at least:
an emotion detection engine to identify a potential interaction involving a user and a participant and process input data including digital information from a plurality of workplace and social information sources compiled to form environment data and profile data for the participant and the interaction, the emotion detection engine to identify a set of potential emotions for the participant with respect to the interaction based on the environment data, the profile data, and an emotional context and to process the set of potential emotions to identify a subset of emotions smaller than the set of potential emotions;
a communication suggestion crafter to receive the subset of emotions and generate at least one suggestion for the user with respect to the participant and the interaction by matching one or more of the emotions from the subset of emotions to a suggested response for a given social context; and
an output generator to formulate the at least one suggestion as an output to the user via digital technology.

2. The apparatus of claim 1, further including an input processor including an interaction detector to identify the interaction and a digital technology compiler to compile information from the plurality of workplace and social information sources to send to the emotion detection engine.

3. The apparatus of claim 1, wherein the output generator further includes a feedback generator to capture feedback from the interaction and provide the feedback to the emotion detection engine.

4. The apparatus of claim 1, wherein the emotion detection engine includes a potential emotions identifier, the potential emotions identifier including a sentiment engine leveraging a neural network to process gathered data to determine the set of potential emotions and to process the set of potential emotions to identify the subset of emotions smaller than the set of potential emotions to provide to the communication suggestion crafter.

5. The apparatus of claim 1, wherein the plurality of workplace and social sources includes at least one of a workforce management system, social media, an electronic medical record system, a scheduling system, or a location system.

6. The apparatus of claim 1, wherein the output includes at least one of a suggested phrase, a reminder, or a cue.

7. The apparatus of claim 6, wherein the output is provided to the user via digital technology including at least one of a phone, a watch, a tablet, an earpiece, glasses, or a contact lens.

8. The apparatus of claim 1, wherein the at least one suggestion is generated using at least one of an emotion-to-language matcher, a natural language processor, or a standard response database.

9. The apparatus of claim 1, wherein the social context is determined based on at least one of cultural information, preference information, or profile comparison information

10. A computer readable storage medium comprising instructions that, when executed, cause a machine to at least:
identify a potential interaction involving a user and a participant;
process input data including digital information from a plurality of workplace and social information sources compiled to form environment data and profile data for the participant and the interaction;
identify a set of potential emotions for the participant with respect to the interaction based on the environment data, the profile data, and an emotional context;
process the set of potential emotions to identify a subset of emotions smaller than the set of potential emotions;
generate at least one suggestion for the user with respect to the participant and the interaction by matching one or more of the emotions from the subset of emotions to a suggested response for a given social context; and
formulate the at least one suggestion as an output to the user via digital technology.

11. The storage medium of claim 10, wherein the instruction further cause the machine to capture feedback from the interaction and provide the feedback to the emotion detection engine.

12. The storage medium of claim 10, wherein the set of potential emotions is determined using a sentiment engine leveraging a neural network to process gathered data to determine the set of potential emotions and to process the set of potential emotions to identify the subset of emotions smaller than the set of potential emotions.

13. The storage medium of claim 10, wherein the plurality of workplace and social sources includes at least one of a workforce management system, social media, an electronic medical record system, a scheduling system, or a location system.

14. The storage medium of claim 10, wherein the output includes at least one of a suggested phrase, a reminder, or a cue.

15. The storage medium of claim 14, wherein the output is provided to the user via digital technology including at least one of a phone, a watch, a tablet, an earpiece, glasses, or a contact lens.

16. A method comprising:
identifying, using a processor, a potential interaction involving a user and a participant;
processing, using the processor, input data including digital information from a plurality of workplace and social information sources compiled to form environment data and profile data for the participant and the interaction;
identifying, using the processor, a set of potential emotions for the participant with respect to the interaction based on the environment data, the profile data, and an emotional context;
processing, using the processor, the set of potential emotions to identify a subset of emotions smaller than the set of potential emotions;
generating, using the processor, at least one suggestion for the user with respect to the participant and the interaction by matching one or more of the emotions from the subset of emotions to a suggested response for a given social context; and
formulating, using the processor, the at least one suggestion as an output to the user via digital technology.

17. The method of claim 16, further including capturing feedback from the interaction and providing the feedback to the emotion detection engine.

18. The method of claim 16, wherein the set of potential emotions is determined using a sentiment engine leveraging a neural network to process gathered data to determine the set of potential emotions and to process the set of potential emotions to identify the subset of emotions smaller than the set of potential emotions.

19. The method of claim 16, wherein the plurality of workplace and social sources includes at least one of a workforce management system, social media, an electronic medical record system, a scheduling system, or a location system.

20. The method of claim 16, wherein the output includes at least one of a suggested phrase, a reminder, or a cue.

21. The method of claim 20, wherein the output is provided to the user via digital technology including at least one of a phone, a watch, a tablet, an earpiece, glasses, or a contact lens.
